(19) United States
(12) Patent Application Publication
(10) Pub. No.: US 2005/0080166 A1
(43) Pub. Date: Apr. 14, 2005

(54) Hydrophilic composite material

(75) Inventors: Harald Keller, 67069 Ludwigshafen (DE); Ekkehard Jahns, Weinheim (DE); Thomas Frechen, 69123 Heidelberg (DE); Wolfgang Schrepp, 69118 Heidelberg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Basf Aktiengesellschaft, ludwigshafen (DE)

(21) Appl. No.: 10/502,587

(22) PCT Filed: Jan. 30, 2003
(86) PCT No.: PCT/EP03/00928

(30) Foreign Application Priority Data
Feb. 8, 2002 (DE) 10205442.8

(51) Int. Cl. B01J 20/26; C08K 3/00; C08K 3/34

(52) U.S. Cl. 524/2; 502/402; 524/445

(57) ABSTRACT

Hydrophilic composite material comprising components A and B, and optionally C, where A is a substance which readily swells with water, B is a substance which forms a porous structure or has a predetermined porous structure, and in whose pores A is present, and C is a binder.

The present invention relates to a hydrophilic composite material comprising components A and B, and also optionally C, where
A is a substance which readily swells with water,
B is a substance which forms a porous structure or has a predetermined porous structure, and in whose pores A is present, and
C is a binder.

A serious problem in industry, particularly in the chemical industry, is that of the deposition and caking of materials in apparatus and in components for apparatus for the construction of plant. The problem particularly affects apparatus walls, container walls, reactor walls, vessel walls, discharge devices, valves, pumps, filters, compactors, centrifuges, columns, dryers, centrifugal separators, scrubbers, comminuters, internals, packings, heat exchangers, evaporators, condensers, nozzles, atomizers, spray dryers, crystallizers, bagging-off systems, and mixing units. These deposits are also termed encrustation or fouling.

This encrustation can hinder or impair the process in many ways and create a need for repeated shutdown and cleaning of the reactors or processing machinery concerned.

Measurement equipment affected by encrustation can be the cause of defective and false results, which can cause operating errors.

Encrustation is also disadvantageous in other sectors. Water leaves residues on surfaces after wetting and evaporation, examples being rainwater on windowpanes, motor vehicles, traffic signs, or billboards. Wetting by flowing liquids causes friction on the surfaces in contact with the flow. Frictional losses are the result, for example in the case of ships, and also in the case of liquids flowing through pipelines.

Encrustation and deposits can be the result of wetting by liquids, e.g. emulsions, suspensions, or polymer dispersions in the interior of process apparatus, such as pipes, vessels, tanks, reactors, heat exchangers, evaporators, condensers, pumps, nozzles, atomizers, spray dryers, crystallizers and bagging-off systems, and also laboratory equipment.

Surface-soiling occurs on electrical apparatus and components in environments subject to weathering or not subject to weathering but in contact with the atmosphere. The surfaces become electrically conducting to some extent as a result of the soiling itself and in particular as a result of moistening of the soiling, e.g. by rain, fog, or atmospheric moisture, the result being leakage currents which can impair the function of the components. In addition, considerable energy losses arise due to soiling of the insulators associated with overhead lines carrying high voltage and with transformers, for example. The soiling is moreover often a cause of corrosion of the installations and a substrate for additional biological contamination, for example by microorganisms, algae, lichens, mosses, or bivalves.

Incomplete wetting (droplet formation) leads to very slow drying of surfaces where droplets are present. This favors the growth of undesirable organisms, such as microorganisms, biofilms, algae, lichens, mosses or bivalves, on surfaces such as walls, roofs, facades, shower cubicles, ships, or heat exchangers.

Wetting causes liquids and liquid-containing substances, such as milk, honey, yoghurt, or toothpaste to remain to some extent on the inner surface of the packaging materials. This means some of the contents cannot be utilized unless complicated cleaning measures are adopted. Contamination by the contents also makes it difficult to recycle packaging materials. Finally, the decay of these residues, which decay easily, also poses a problem of hygiene and particularly in summer is the cause of unpleasant odors in the vicinity of trash containers.

When solid surfaces come into contact with particles, adhesion occurs. Adhesion of particles such as dirt, dust, carbon black, industrial powders, pollen, spores, bacteria, or viruses leads to contamination of the surfaces and is undesirable in many instances.

Another problem produced by the formation of deposits arises from the fact that, particularly in encrustation in polymerization reactors, molecular parameters such as molecular weight or degree of crosslinking deviate markedly from product specifications. If deposits break away while the operation is running, they can contaminate the product (e.g. specks in coatings, inclusions in suspension beads). Another effect of undesired deposits on reactor walls, packings, or mixing units is undesired change in the residence time profile of the apparatus, or impairment of the effectiveness of the internals or mixing units themselves. If large sections of encrustation break away, they can cause blocking of discharge apparatus and work-up apparatus, and small sections can impair the resultant product.

The deposits whose formation is to be prevented are encrustation which can be caused by reactions with and on surfaces, for example. Other causes are adhesion to surfaces, which can be the result of van der Waals forces, polarization effects, or electrostatic double layers. Other important effects are stagnation of the movement at the surface and, in some cases, reactions in the stagnant layers mentioned. Finally, mention should be made of: precipitates from solutions, evaporation residues, cracking on hot areas of surfaces, and also microbiological activity.

The causes depend on the particular combinations of substances and can act alone or in combination. Whereas the processes underlying the undesired encrustation have been studied very thoroughly (e.g. A. P. Watkinson and D. I. Wilson, Experimental Thermal Fluid Sci. 1997, 14, 361 and references cited therein) there is little coherent thinking concerning prevention of the deposits described above. The methods known to date have technical disadvantages.

Mechanical solutions have the disadvantage of giving rise to considerable additional costs. Additional reactor internals can moreover change the flow profile of fluids in the reactors markedly, and therefore require expensive redevelopment of the process. Chemical additives can cause undesired contamination of the product, and some additives pollute the environment.

For these reasons, increasing efforts are being made to find ways of directly lowering the level of tendency toward fouling by modifying apparatus and components of apparatus for the construction of chemical plant.

WO 00/40775, WO 00/40774, and WO 00/40773 describe processes for coating surfaces, specifically surfaces of reactors for high-pressure polymerization of 1-olefins, or surfaces of heat exchangers, by currentless deposition of an NiP/polytetrafluoro-ethylene layer, or of a CuP/polytetrafluoroethylene layer. This deposition can modify the metal surfaces concerned so that they become antiadhesive. However, when the surfaces coated by the process described are used in apparatus or in components of apparatus for the construction of chemical plant, specifically reactors for high-pressure polymerization of 1-olefins, it is found that the surfaces lack sufficient mechanical stability and therefore after prolonged use product caking is again observed. Recoating of a partially ablated NiP/polytetrafluoroethylene layer is unsuccessful. Furthermore, it has been found that once an NiP/polytetrafluoroethylene layer has been precipitated it is difficult to remove if it is no longer desired in a reactor or a component of apparatus. It is particularly in reactors with rapid product change, where reactions at above 400° C. also sometimes have to be carried out, that a coating using NiP/polytetrafluoro-ethylene has not proven successful. Finally, another disadvantage which may be mentioned is that, particularly during the coating of large-volume reactors, large amounts of immersion baths have to be used and are the cause of considerable solvent waste.

WO 96/04123 discloses self-cleaning surfaces which can be covered with polytetrafluoroethylene, and which have particularly hydrophobic properties. The structuring is achieved by etching or embossing the surface, using physical methods, such as sandblasting, or ion etching, for example using oxygen. The distance between the elevations or, respectively, depressions is more than 5 μm. The surface is then coated with Teflon. However, the mechanical stability of layers hydrophobicized in this way is much too low for use in chemical engineering, in particular for polymerization reactions, where severe shear forces have effect. The layers applied in this way are moreover insufficiently transparent for numerous applications.

Structured surfaces with hydrophobic properties are also known (EP-A 0 933 388), an example of a method for producing these being to etch the surface concerned, thus producing elevations or grooves with separation of less than 10 μm on the surface, and then covering the material with a layer of a hydrophobic polymer, such as polyvinylidene fluoride, the surface energy of the material concerned here being less than 20 mN/m. These layers may also comprise fluorinated waxes, such as Hostaflon® grades. Surfaces modified in this way are hydrophobic and oleophobic. Applications mentioned are wafer holders in semiconductor production and the production or coating of headlamps, or of wind shields, or protective covers for solar cells. However, a disadvantage of the process is that after partial mechanical degradation of the structuring it is difficult to renew.

It is an object of the present invention, therefore, to provide
a process which gives surfaces dirt-repellant properties and which avoids the disadvantages mentioned of the prior art,
dirt-repellant surfaces, and
uses for articles with dirt-repellant surfaces.

We have found that this object is achieved by means of the hydrophilic composite materials defined at the outset.

The components here are defined as follows:

A is a substance which readily swells with water, for example a gel. Its water absorption at 20° C. is more than 10% by weight, preferably more than 20% by weight, measured to ISO 8361.

It is advantageous for component A to be one or more organic polymers or copolymers, where the structure of the polymers may be linear, comb-type, star-type (“dendrimers”), branched, hyperbranched, or crosslinked. Examples of structures of copolymers whose selection is advantageous are random, alternating, block-type, in particular grafted, linear, branched, star-type (“dendrimers”), hyperbranched, or crosslinked.

A is preferably composed of one or more polymers or copolymers which contain nitrogen atoms or contain oxygen atoms, particularly preferably of polymers which contain nitrogen atoms and contain oxygen atoms. It is possible here for the location of the nitrogen atoms or oxygen atoms to be in the main chain or side chain of the polymers concerned. The molar ratio of the total number of nitrogen atoms and oxygen atoms to that of carbon atoms is particularly preferably from 2:1 to 1:5, in particular from 3:2 to 1:3.

If component A is selected from copolymers of block-type structure, e.g. block copolymers and in particular graft copolymers, then at least one block has a molar ratio of the total number of nitrogen atoms and oxygen atoms to that of the carbon atoms of from 2:1 to 1:5, in particular from 3:2 to 1:3.

The polymers suitable as component A have underlying structures composed of the units 1 to 4 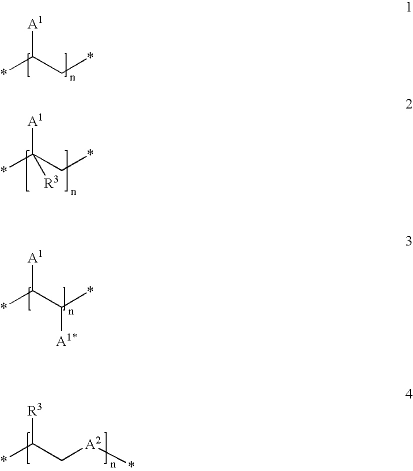
and other polymers suitable as component A have two or more of the various units 1 to 3.

Examples of polymers suitable as component A are polymers having the following polar structural units A¹ and A¹*
—SO₃H, —SO₃—X⁺, —PO₃H₂, —PO₃²⁻2 X⁺, —O—PO₃H₂, —COOH, —COOR¹, —COO^{-X}⁺,
—C(O)NR¹R², —O—C(O)NR¹R²,
—OH, —OCH₃.

Within the chain of the polymers suitable as component A there may be the following structural units A², for example:
—O—, —C(O)O—, —O—C(O)O—, —NR¹—C(O)NR²—, —O—C(O)NR¹—CH₂CH₂O—, —C(O)NR¹C(O)—,
—O—C(O)NR¹C(O)—, —O—C(O)NR¹C(O)—O—, —C(O)NR¹C(O)NR²—,
—O—C(O)NR¹C(O)NR²—,
—O—C(O)NR¹C(O)—O—.
x is Li, Na, K, Rb, Cs or ammonium ions of the formula N(R³)₄;
R¹ and R² are identical or different, and each is H, or C₁-C₄-alkyl, selected from methyl, ethyl, n-propyl, isopropyl, n-butyl, iso-butyl, sec-butyl, and tert-butyl;
n is an integer in the range from 8 to 80 000.
R³ are identical or different, and each is selected from hydrogen;
C₁-C₄-alkyl, selected from methyl, ethyl, n-propyl, isopropyl, n-butyl, isobutyl, sec-butyl, and tert-butyl;
—CH₂—CH₂—OH
benzyl, or C₆-C₁₄-aryl, preferably phenyl.

The following ammonium ions may be mentioned by way of example: NH₄⁺, CH₃NH₃⁺, (CH₃)₂NH₂⁺, (CH₃)₃NH⁺, (CH₃)₄N⁺, C₂H₅NH₃⁺, H₂N(CH₂CH₂OH)₂⁺, HN(CH₂CH₂OH)₃⁺, CH₃NH(CH₂CH₂OH)₂⁺, n-C₄H₉NH(CH₂CH₂OH)₂⁺.

Other advantageous polar units A¹ or A¹* are the units 5 to 13, single-bonded to the polymer chain.

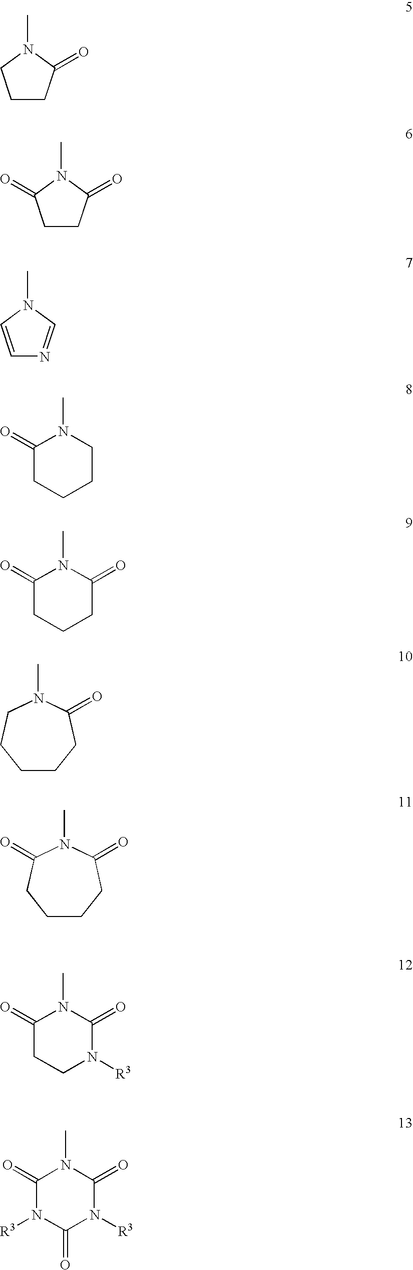

The elements 5 to 13 may be within the main polymer chain or main copolymer chain, or—in the case of a branched or crosslinked polymer or copolymer, for example—within the polymer side chains.

The distribution of the units 5 to 13 across the polymer molecule may be uniform, i.e. random or alternating, or non-uniform, as is the case with block copolymers and in particular with graft copolymers, for example.

The polymers or copolymers of component A according to the invention may contain the units 1a or 2a 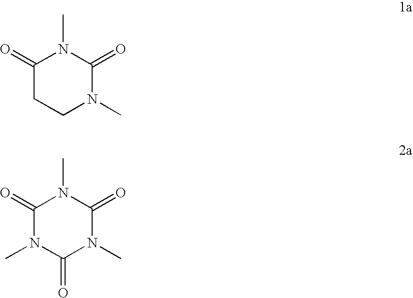
bonded to the polymer chain as structural units A¹ or A¹*, these units preferably being used by the polymers to form branched or crosslinked structures.

The elements 1a-2a may be within the main polymer chain or main copolymer chain, or—in the case of a branched or crosslinked polymer or copolymer, for example—within the polymer side chains.

The distribution of the units 1a-2a across the polymer molecule may be uniform, i.e. random or alternating, or non-uniform, as is the case with block copolymers, for example.

Preference is moreover given to polar structural elements which are non-ionizable at pH values of from 3 to 12, for example polyurethane units, polyethylene glycol units, polyvinylpyrrolidone units, polyvinylformamide units, polyvinyl alcohol units, or polysaccharide units.

If component A is composed of two or more polymers, preference is given to polymers which form complexes with one another. Examples of these are the combinations poly(meth)acrylic acid/polyethylene oxide, poly(meth)acrylic acid/polyvinylpyrrolidone, and poly(meth)acrylic acid/polyvinylformamide.

The polymers or copolymers of component A according to the invention advantageously have a molar mass Mₙ of from 1 000 to 10 000 000 g/mol, preferably from 5 000 to 2 000 000 g/mol, and a polydispersity of from 1.1 to 10, preferably from 1.5 to 7, determined by gel permeation chromatography.

As component B, the composite materials comprise a substance which forms a porous structure or which has a predetermined porous structure. B preferably has low swellability with liquids, in particular water. For the purposes of the present invention, component B also includes substances which have a particulate structure. For the purposes of the present invention, substances forming a porous structure are defined to include those which have an existing porous structure. For the purposes of the present invention, low swellability means in particular that liquid absorption and in particular water absorption at 20° C. is below 10% by weight, measured to ISO 8361.

B gives the composite material mechanical strength, and forms pores into which A is embedded.

In one embodiment of the present invention, B is a material whose existing form is porous. By way of example, mention may be made of foams made from rigid polyurethane, and also of porous glasses, textiles, nonwovens, leather, wood, paper, polymer membranes, porous inorganic materials, such as sandstone, concrete, clay, silicon dioxide, gypsum and in particular alabaster, and chalk.

In another embodiment of the present invention, B is composed of solid particles which form a porous structure together with A and optionally with binder C.

Examples are fumed silica, fumed titanium dioxide, fumed aluminum oxide, nano particles, e.g. colloidal silica gel (Ludox®), colloidal aluminum oxide, kieselguhr (diatomaceous earth); inorganic powders, for example those derived from insoluble silicates, from phosphates, from carbonates, from sulfates, or from carbides; quartz, aluminum oxide or boehmite; natural or synthetic fibers derived from wool, cotton, hemp, polyester, polyamides, or polypropylene; polymer powders, e.g. isotactic polypropylene, atactic or syndiotactic polystyrene, polyethylene, such as HDPE or LDPE, or micronized waxes, such as polyethylene waxes, or polypropylene waxes, or paraffin waxes.

In one preferred embodiment of the present invention, the ratio of the volume of A to the pore volume of B in the swollen state is from 1:100 to 10:1, particularly preferably from 1:10 to 7:1. The pores of B may have various shapes. The pore diameter is usually from 0.001 to 500 μm, preferably from 0.01 to 100 μm. The pore depth is usually from 0.001 to 500 μm, preferably from 0.01 to 100 μm.

Pore volume, pore diameter, and pore depth are determined by commonly used test methods, such as BET nitrogen adsorption or mercury porosimetry.

If B is a particulate substance, the particle diameter is usually from 0.001 to 500 μm, preferably from 0.05 to 100 μm.

In one particular embodiment of the present invention, binders C are added to the composite materials of the invention. C are binders other than A and B, and increase the strength of the composite material of the invention. Examples are commercially available polymers, e.g. polyvinyl chloride, atactic or syndiotactic polystyrene, isotactic polypropylene, polyethylene, such as HDPE or LDPE, polymethyl methacrylate, polyisobutene, or polyurethane. Other examples are inorganic binders, e.g. waterglass, silica sols, colloidal SiO₂. The weight ratios of B to C are generally non-critical, and are from 10:99 to 95:5, preferably from 30:70 to 90:10.

The present invention also provides the use of the composite materials of the invention for coating substrates, and also a process for coating substrates, using the composite materials of the invention. The processes of the invention also include those embodiments of the process in which a porous substrate is coated with the substance which readily swells with water, and the substance penetrates into the uppermost layer of the substrate.

One embodiment of the process of the invention consists in applying the composite materials of the invention in a liquid formulation to the surfaces, for example by spraying, dipping, or roller application, or by the Foulard process. If B has an existing porous structure it is advantageous for the composite materials of the invention to be applied by impregnation processes known per se.

In another embodiment of the process of the invention, the composite materials of the invention are applied in a solid formulation to the surface, preferably by powder coating similar to the powder coating process conventionally used in automotive painting technology.

It is advantageous for there to be a fixing step after the application of the composite materials of the invention, when producing the surfaces of the invention, for example a thermofixing step at from 80 to 250° C., preferably from 100 to 210° C., for from 10 minutes to 24 hours. It is also possible for the fixing process to be promoted by adding a crosslinker during application of the composite materials of the invention. Examples of suitable crosslinkers are free-radical generators activated thermally or by exposure to UV light.

Another aspect of the present invention is surfaces of substrates which have a coating made from the composite materials of the invention. The surfaces of the invention feature a high level of hydrophilic properties, and a particular feature is that water does not form droplets on the surfaces of the invention. Inorganic and organic dirt are also easy to remove from the surfaces of the invention. Substrates which may be coated are a very wide variety of inorganic or organic materials. Examples are inorganic materials such as sandstone, concrete, clay, sanitary ceramics, metals, and alloys, such as steel, foams made from rigid polyurethane, and also glasses, textiles, nonwovens, leather, wood, paper, and polymer membranes.

Examples are used to illustrate the invention.

### EXAMPLES

1. Production of Composite Materials

1.1. Glass and Polyvinylpyrrolidone

A porous glass disk commercially available from ROBU Glasfiltergeräte GmbH, with diameter of 4 cm and thickness of 0.4 cm, and with pore widths of 1 to 1.6 μm is dipped into a solution of 5 g of polyvinylpyrrolidone with K value of 30 (commercially available from Aldrich) in 95 g of deionized water, and heated to 98° C. for 10 min. After cooling, the glass disk is removed from the solution and dried for a period of 17 h at 20° C.

The glass disk is then heat-conditioned for a period of 3 hours at 200° C.

Water droplets are applied to the treated glass plate. The treated glass plate is very effectively wetted by water. No droplets form on the glass plate.

1.2. Glass and Polyethylene Glycol

A porous glass disk commercially available from ROBU Glasfiltergeräte GmbH, with diameter of 4 cm and thickness of 0.4 cm, and with pore widths of 1 to 1.6 μm is dipped into a solution of 5 g of polyethylene glycol (molar mass Mₙ=4 600 g/mol; Aldrich) in 95 g of deionized water, and heated to 98° C. for 10 min. After cooling, the glass disk is removed from the solution and dried for a period of 17 h at 20° C.

The glass disk is then heat-conditioned for a period of 3 hours at 175° C.

Water droplets are applied to the treated glass plate.

The treated glass plate is very effectively wetted by water. No droplets form on the glass plate.

1.3. Glass and Polyacrylic Acid

A porous glass disk commercially available from ROBU Glasfiltergeräte GmbH, with diameter of 4 cm and thickness of 0.4 cm, and with pore widths of 1 to 1.6 μm is dipped into a solution of 5 g of polyacrylic acid (molar mass M_{w}=250 000 g/mol; Aldrich) in 95 g of deionized water, and heated to 98° C. for 10 min. After cooling, the glass disk is removed from the solution and dried for a period of 17 h at 20° C.

The glass disk is then heat-conditioned for a period of 3 hours at 175° C.

Water droplets are applied to the treated glass plate.

The treated glass plate is very effectively wetted by water. No droplets form on the glass plate.

1.4. Glass and Polyethylene Oxide and Polyacrylic Acid

A porous glass disk commercially available from ROBU Glasfiltergeräte GmbH, with diameter of 4 cm and thickness of 0.4 cm, and with pore widths of 1 to 1.6 μm is dipped into a solution of 2.5 g of polyacrylic acid (molar mass M_{w}=250 000 g/mol; Aldrich) and 2.5 g of polyethylene glycol (molar mass Mₙ=4 600 g/mol; Aldrich) in 95 g of deionized water, and heated to 98° C. for 10 min. After cooling, the glass disk is removed from the solution and dried for a period of 17 h at 20° C.

The glass disk is then heat-conditioned for a period of 3 hours at 175° C.

Water droplets are applied to the treated glass plate. The treated glass plate is very effectively wetted by water. No droplets form on the glass plate.

2. Dirt Removal Test

2.1. Removal of Inorganic Dirt—General Procedure

The treated glass plates from examples 1-4 are soiled with magnetite powder (particle size <5 μm; Aldrich) and then rinsed under running water.

A greater percentage of the magnetite powder is removed, and markedly more rapidly, than is the case during a comparative experiment with an untreated glass plate.

2.2. Removal of Organic Dirt—General Procedure

The treated glass plates from examples 1-4 are soiled with carbon black powder (Printex® V; Degussa AG) and then rinsed under running water.

A greater percentage of the carbon black powder is removed, and markedly more rapidly, than is the case during a comparative experiment with an untreated glass plate.

Dirt removal is qualitatively better for glass plates which have been treated (examples 1, 2 and 4) with polymers which have polar structural elements which are non-ionizable at pH values of from 3 to 12 than for the glass plate treated with polyacrylic acid, which is ionizable at pH>7 (example 3).

1. A hydrophilic composite material comprising components A and B, and also optionally C, where
A is a substance which readily swells with water,
B is a substance which forms a porous structure or has a predetermined porous structure, and in whose pores A is present, the pore diameter being from 0.001 μm to 500 μm and the pore depth being from 0.001 μm to 500 μm and
C is a binder.

2. A hydrophilic composite material as claimed in claim 1, wherein A is a gel.

3. A hydrophilic composite material as claimed in claim 1 wherein B is an inorganic particulate or porous material.

4. A composite material as claimed in claim 1, wherein the pore diameter of B is from 0.01 to 100 μm and the pore depth is from 0.01 to 100 μm.

5. A composite material as claimed in claim 1, wherein the water absorption of A at 20° C. is more than 10% by weight.

6. A composite material as claimed in claim 1, wherein A is composed of one or more organic polymers or copolymers.

7. A composite material as claimed in claim 1, wherein component A contains polar structural elements which are non-ionizable at pH values of from 3 to 12, for example polyurethane units, polyethylene glycol units, polyvinylpyrrolidone units, polyvinylformamide units, polyvinyl alcohol units, or polysaccharide units.

8. A composite material as claimed in claim 1, wherein A is composed of two or more organic polymers or copolymers which form polymer complexes with one another.

9. A composite material as claimed in claim 1, wherein A is composed of one or more polymers or copolymers which contain nitrogen atoms or contain oxygen atoms.

10. A composite material as claimed in claim 1, wherein A is composed of one or more polymers or copolymers which contain nitrogen atoms or contain oxygen atoms, where the molar ratio of the total number of nitrogen atoms and oxygen atoms to that of carbon atoms is from 2:1 to 1:5.

11. A composite material as claimed in claim 1, wherein B is a low-swellability substance whose water absorption at 20° C. is below 10% by weight.

12. A composite material as claimed in claim 1, wherein the ratio of the volume of A to the pore volume of B is in the range from 1:100 to 10:1.

13. The use of composite materials as claimed in claim 1 for giving surfaces hydrophilic properties.

14. A process for giving surfaces hydrophilic properties, using composite materials as claimed in claim 1.

15. A process as claimed in claim 14, wherein the composite material is applied in a liquid formulation to surfaces.

16. A process as claimed in claim 14, wherein the composite material is applied in a solid formulation to surfaces.
